(19) United States
(12) Patent Application Publication
(10) Pub. No.: US 2019/0004375 A1
(43) Pub. Date: Jan. 3, 2019

(54) OPTICAL FILM, BACKLIGHT MODULE AND DISPLAY DEVICE FOR BACKLIGHT MODULE

(71) Applicant: Shenzhen China Star Optoelectronics Technology Co. Ltd., Shenzhen, Guangdong (CN)

(72) Inventors: Jianyu CHANG, Shenzhen, Guangdong (CN); Yung-jui LEE, Shenzhen, Guangdong (CN); Yu-chun HSIAO, Shenzhen, Guangdong (CN); Sheng-Jer CHANG CHIEN, Shenzhen, Guangdong (CN); Zanjia SU, Shenzhen, Guangdong (CN)

(73) Assignee: Shenzhen China Star Optoelectronics Technology Co. Ltd., Shenzhen, Guangdong (CN)

(21) Appl. No.: 15/558,188

(22) PCT Filed: Jul. 18, 2017
(86) PCT No.: PCT/CN2017/093257

§ 371 Date: Sep. 13, 2017

(30) Foreign Application Priority Data
May 4, 2017 (CN) 201710309557.7

(51) Int. Cl. G02F 1/1335; F21V 8/00

(52) U.S. Cl. CPC G02F 1/133617; G02B 6/0055; G02B 6/005; G02B 6/0051; G02F 1/133603; G02F 1/133606; G02F 1/133605; G02F 2001/133607; G02F 2001/133614; G02B 6/0053

(57) ABSTRACT

The present disclosure discloses an optical film, a backlight module and a display device for a backlight module, and relates to a liquid crystal panel display technology field. The backlight module including: a light source emitting at least a first light; the optical film includes a light converting material which receives the first light and converts it into at least a second light exit such that the light emitting angle of the backlight module is greater than 120 degrees. In the above-described manner, the present disclosure enables the backlighting angle of the backlight module to be greater than 120 degrees, and the display device having the backlight module can be brought to a wide viewing angle effect.

### FIELD OF THE DISCLOSURE

The present disclosure relates to a liquid crystal panel display technology field, and more particularly to an optical film, a backlight module and a display device for a backlight module.

### BACKGROUND OF THE DISCLOSURE

Liquid crystal display (LCD) with light, low power consumption, no radiation and other characteristics, has now occupied the leading position in the field of display, at present, liquid crystal display is widely used in high-definition digital TV, desktop computers, tablet PCs, notebook computers, mobile phones, digital cameras and other electronic equipment.

The inventors of the present application have found that in the conventional research, when the backlight passes through a polarizer, a TFT, or the like in the prior art, the output of the light will have a direction, in which most of the light from the screen in the vertical shot out; that is, in different locations on the LCD monitor screen will have different colors, especially when viewed from a larger angle to the LCD, they can not see the original color of the screen, or even only see the whole white or all black, that is often said that the lack of perspective. With the increasing size of the LCD, the probability of viewing the display from the side is increasing, so it is necessary to develop a display device with wide viewing angle.

### SUMMARY OF THE DISCLOSURE

The technical problem that the present disclosure mainly solves is to provide an optical film, a backlight module and a display device for a backlight module, which can make the display device have a large viewing angle and achieve a better display effect.

In order to solve the above-mentioned technical problems, a technical solution adopted by the present disclosure is to provide an optical film for a backlight module, including a light conversion material, the light conversion material receives the first light and converts it into at least a second light exit such that the light exit angle of the light conversion material is greater than 130 degrees, the color temperature is less than 16000, the contrast is greater than 1500:1; the concentration of the light conversion material in the light conversion film is 0.2% to 25%; the light converting material includes a quantum dot material and/or a fluorescent material.

In order to solve the above technical problems, a technical aspect of the present disclosure is to provide a backlight module including a light source for emitting at least a first light; the optical film includes a light converting material that receives the first light and converts it into at least a second light exit such that the light exit angle of the backlight module is matched with a wide viewing angle greater than 120 degrees.

In order to solve the above-mentioned technical problems, another aspect of the present disclosure is to provide a display device including the above-described backlight module.

An advantageous effect of the present disclosure is that, in contrast to the prior art, the present disclosure provides a backlight module including an optical film including a light conversion material, the light conversion material receives the first light and converts it into at least a second light exit so that the light exit angle of the backlight module is greater than 120 degrees, thereby enabling the display device having the backlight module to achieve a wide viewing angle effect.

### BRIEF DESCRIPTION OF THE DRAWINGS

FIG. 1 is a schematic structural view of an embodiment of the backlight module of the present disclosure;

FIG. 2 is a comparison view of the brightness viewing angle of the backlight module of the present disclosure and the conventional backlight module;

FIG. 3 is a schematic structural view of another embodiment of the backlight module of the present disclosure;

FIG. 4 is a schematic structural view of a further embodiment of the backlight module of the present disclosure;

FIG. 5 is a schematic view showing the direction of each ray in yet another embodiment of the backlight module of the present disclosure;

FIG. 6 is a schematic structural view of an embodiment of an optical film for a backlight module of the present disclosure;

FIG. 7 is a schematic view of an embodiment of a display device according to the present disclosure.

### DETAILED DESCRIPTION OF PREFERRED EMBODIMENTS

The present disclosure will now be described in more detail with reference to the accompanying drawings, in which the present disclosure will be described more fully by way of example with reference to the accompanying drawings.

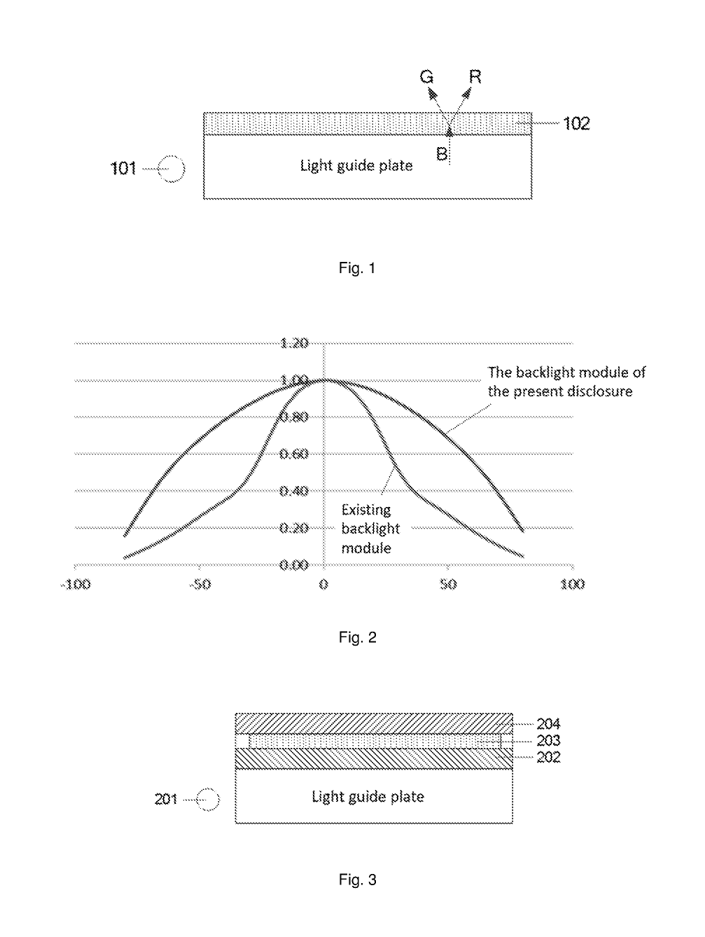

Please refer to FIG. 1, FIG. 1 is a schematic structural view of an embodiment of the backlight module of the present disclosure. The present disclosure provides a backlight module for providing a backlight for a display device. The backlight module includes a light source 101 and an optical film 102.

The light source 101 may be a point light source, a line light source or a surface light source capable of emitting at least a first light; the light source 101 may be a Light Emitting Diode (LED), the LED light can emit a variety of colors such as ultraviolet light or blue light. In other embodiments, the backlight light source may also be other light-emitting chips or the like.

Please refer to FIG. 2, FIG. 2 is a comparison view of the brightness viewing angle of the backlight module of the present disclosure and the conventional backlight module. The optical film 102 includes a light conversion material that receives the first light and converts it into at least a second light exit such that the light exit angle of the backlight module is matched with a wide viewing angle greater than 120 degrees. Such as 120 degrees, 150 degrees, 170 degrees, etc., to meet the wide viewing angle display requirements, and thus can make the display device to achieve wide viewing angle effect.

Wherein the concentration of the light converting material in the light conversion film is 0.2% to 25%, wherein the concentration may be a mass content or a volume content, specific according to the light conversion material, density, size, the material type of the base material, and the like, and the concentration in the other embodiments may also be the mass content or the volume content. As the concentration of the light conversion material increases, the color temperature of the backlight module will decrease, therefore, in order to reduce the color temperature of the backlight module, the concentration of the light conversion material can be appropriately increased, for example, 0.2%, 1%, 6%, 13%, 25%, etc., so that the color temperature of the backlight module is reduced to 16000 or less, such as 14000, 11000, 9000, 7000 and so on.

Alternatively, in one embodiment, the backlight module provided herein has a large viewing angle, low color temperature, and its contrast is greater than 1500:1, for example 1500:1, 3000:1, 5000:1, and the like.

Wherein, the first ray is ultraviolet light or blue light, the second ray is yellow light, or a mixed light of green and red light, or a mixed light of blue light, green light and red light.

Wherein the light conversion material converts the first light to a second light exit of the same or different wavelength. Specifically, when the first light is blue, the light conversion material receives the blue light to emit a second light consisting of a mixture of green and red light of different wavelengths, or the light conversion material receives blue light to emit yellow light having the same wavelength as the second light; when the first light is violet, the light conversion material receives the purple light to emit a second light consisting of a mixture of blue, green and red light of different wavelengths.

Optionally, in one embodiment, the optical film 102 includes a layer of a light conversion material having a film thickness of 70 to 135 microns, such as 75 microns, 95 microns, 115 microns, 135 microns, the film is too thick to increase the consumption and loss of light, the film is too thin light conversion rate will be reduced. At the same time, the color temperature of the backlight module decreases as the film thickness increases, so that the thickness of the light conversion material layer can be appropriately increased in order to reduce the color temperature of the backlight module.

Optionally, in one embodiment, the light converting material includes a quantum dot material and/or a fluorescent material. Quantum dots (QD) refers to the three-dimensional size in the order of nano-granular material, the quantum dots in the light exposure can be entered into the excited state, and in the excited state down to the ground state when the specific wavelength of light (that is, a specific color), QD emission spectrum is mainly controlled by the size of QD particles, so you can change the particle size of QD to achieve the emission spectrum of the regulation; at the same time, QD conversion efficiency is high, can improve the utilization of light, QD emission spectrum half-wave width is very narrow, good temperature stability. The material of the quantum dots may be the II-VI quantum dots, the I-III-VI quantum dots, and the mixture of different quantum dots; in particular, the quantum dot material may be one or more of ZnCdSe₂, CdSe, CdTe, CuInS₂, ZnCuInS₃. The size of the quantum dot, the type of material, the type of fluorescent material can be selected according to the actual needs of the deployment.

Alternatively, in one embodiment, the ratio of the quantum dot material to the fluorescent material is from 1:100 to 1:5, such as 1:100, 1:70, 1:40, 1:20, 1:5, the light conversion efficiency of the quantum dot material is higher than that of the ordinary fluorescent material, but the price of the quantum dot material is more expensive than that of the ordinary fluorescent material. If the whole piece of the light conversion film is selected as the quantum dot material, the preparation cost is increased, and even if the amount of quantum dots is increased after the light conversion efficiency reaches a certain value, the effect of the final display is not big, resulting in the waste of resources. Therefore, in this embodiment, the combination of the quantum dot material and the fluorescent material is used to ensure both the light conversion efficiency and the cost.

Alternatively, in one embodiment, the quantum dot material has a particle size of 1 to 20 nm, for example: 1 nm, 5 nm, 8 nm, 15 nm, 20 nm; the quantum dot material includes a blue quantum dot material, a green quantum dot material, a red light quantum dot material, wherein the concentration of the blue quantum dot material in the quantum dot material is 40% to 65% when a non-blue light source such as an ultraviolet light source is used, for example: 40%, 45%, 50%, 55%, 65%; the concentration of green quantum dot material in the quantum dot material is 15% to 45%; for example: 15%, 25%, 35%, 40%, 45%; the concentration of red quantum dot material in the quantum dot material is 12% to 28%; for example: 12%, 15%, 18%, 22%, 28%; green light quantum dot material and red light quantum dot material ratio of 3:1˜1.2:1; For example, 3:1, 2.5:1, 2:1, 1.5:1 and so on. When using a blue light source, can not contain blue quantum dot material, green light quantum dot material and red light quantum dot material can be adjusted according to the above distribution. Among them, the quantum dot material particle size distribution should be uniform to improve the light purity, blue quantum dot material is mainly used to absorb the first light to convert it into a second light, such as conversion to green and red, so its content is more; and green light is easily absorbed into red light, so in order to make the final white light emitted more uniform, green light quantum point material content should be more than the amount of red light quantum material, so that the final white light in the proportion of three light about blue light 10% to 30%, green light 30% to 70%, red light 20% to 40%.

Optionally, in one embodiment, the optical film 102 includes a laminated base layer and a functional layer, the substrate being a carrier carrying or supporting a functional layer, the material of which may be a glass or a polymeric material; the functional layer is at least one of a diffusion film, a brightness enhancement film, a reflective film, and a prism film, the light conversion material may be doped in the functional layer or may be doped in the base layer in any of the above-mentioned film layers; in another embodiment, the optical film 102 may not include a base layer, but only a functional layer. The doped light conversion material can enhance the scattering of light, which makes the optical film 102 further enhance the scattering of light on the basis of the original function, so that the light emitting angle of the backlight module can be increased without changing the structure of the original backlight module, and the display device having the backlight module can be made to have a wide viewing angle effect.

In other embodiments, the backlight module may include only one of the above-described film layers, or may include two or more of the above-described film layers, when two or more layers are contained, the light conversion materials added to the different layers may be the same or different, when the light conversion material added in the different layers is different, an optical film can be used to convert the first light to the second light exit, another optical film converts the second light into a third light exit. Specifically, when the first light is blue, an optical film receives blue light to emit a second light consisting of a mixture of green and red light of different wavelengths, another type of optical film receives green light from the second light to emit red light with the same wavelength as the third light.

Please refer to FIG. 3, FIG. 3 is a schematic structural view of another embodiment of the backlight module of the present disclosure. In one embodiment, the optical films 202 and 204 include a functional layer including at least two of a diffusion film, a brightness enhancement film, a reflective film, and a prism film, at least two functional layers are bonded through an optical glue 203, and the light conversion material is dispersed in the optical glue 203. The optical glue doped with the light conversion material can play the light scattering effect, the same can not change the original backlight module structure in the case of increasing the brightness of the backlight module, and the display device having the backlight module is brought to a wide viewing angle effect. In another embodiment, the at least two functional layers described above completely encapsulate the optical adhesive layer 203. Because the light conversion material is generally more sensitive to water vapor and oxygen, in the course of the use of easy to failure, the use of two functional layers completely wrapped in optical glue layer, the optical adhesive layer can be sealed to protect the purpose of light conversion materials, at the same time do not need to set the protective layer, reduce costs, making simple.

Optionally, in one embodiment, the optical film 102 includes a reflective film layer arranged on one side of the light conversion material on the optical path away from the light source 101, a portion of the first light passes through the light conversion material and is emitted onto the reflective film layer and is partially reflected back to continue the conversion of the first light to the second light. By providing a reflective film layer, it is possible to reflect a part of the light back while scattering a part of the light, to re-energize the light, to improve the light utilization efficiency, to enhance the brightness, and to have a better display effect.

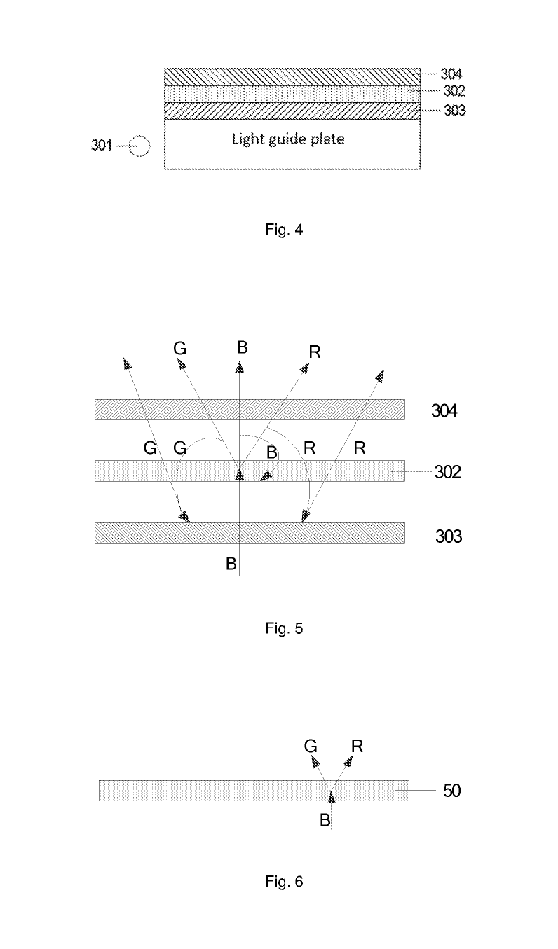

Please refer to FIG. 4 and FIG. 5, FIG. 4 is a schematic structural view of a further embodiment of the backlight module of the present disclosure; FIG. 5 is a schematic view showing the direction of each ray in yet another embodiment of the backlight module of the present disclosure. In one embodiment, the backlight module further includes: a first transflective film 303 arranged on the optical path adjacent to the light source 301 on the optical path, passing through the first ray and reflecting light outside the first ray; a second transflective film 304 arranged on the optical path away from the light source 301 on the optical path, at least partially reflecting the first light and passing through the light other than the first light. By providing a first transflective film, it is possible to selectively pass through the first light, improve the purity of the first ray, and enhance the excitation efficiency; by providing a second transflective film, it is possible to transmit light in addition to the first light to form a white light to provide a backlight light source; and at the same time be able to partially reflect the first light, again excited to generate a second light to improve the first light utilization, enhance the brightness. In another embodiment, it is also possible to provide the transflective film only on the side of the optical path on the optical path away from the light source.

In the case of a blue light source, the first transflective film 303 can transmit blue light (B) and reflect light other than blue light; blue light is absorbed by the light conversion material to generate red light (R) and green light (G), the generated red and green light and part of the blue light can be mixed through the second transflective film 304 to produce white light to provide backlighting; the generated partial red and green light can not be reflected back through the first transflective film 303, re-ejected, and the light utilization efficiency is improved; at the same time, part of the blue light is reflected back after the light conversion material to re-stimulate the absorption, increase the number of excitation, improve light utilization.

Alternatively, in another embodiment, the backlight module may also provide a backlight for the display device as a direct light source.

Please refer to FIG. 6, FIG. 6 is a schematic structural view of an embodiment of an optical film for a backlight module of the present disclosure. The present disclosure also provides an optical film 50 for a backlight module including an optical conversion material, the light conversion material receives the first light and converts it to at least a second light exit such that the light exit angle of the backlight module is greater than 120 degrees. The optical film 50 may be any one of the optical films in the above-described embodiment, and will not be described again. It can also be a multi-functional film with both diffusion, brightening and so on.

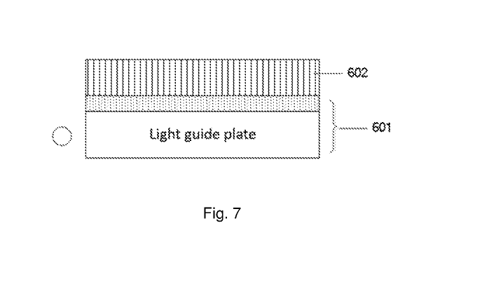

Please refer to FIG. 7, FIG. 7 is a schematic view of an embodiment of a display device according to the present disclosure. The present disclosure provides a display device including a backlight module 601 and a liquid crystal display panel 602, and the structure of the backlight module 601 is the same as that of the above embodiment and will not be described again; the structure of the liquid crystal display panel 602 is a conventional structure. The backlight module of the display device has a large light exit angle, and the display device has a large viewing angle, and the display effect is better.

In summary, the present disclosure provides a backlight module including an optical film including a light conversion material, the light conversion material receives the first light and converts it into at least a second light exit so that the light exit angle of the backlight module is greater than 120 degrees, thereby enabling the display device having the backlight module to achieve a wide viewing angle effect.

The foregoing is merely an embodiment of the present disclosure and is not intended to limit the scope of the disclosure, any equivalent or equivalent process transformation made using the present specification and the accompanying drawings, either directly or indirectly, in other related technical fields, is likewise included within the scope of the patent protection of the present disclosure.

What is claimed is:

1. An optical film for a backlight module, comprising: a light conversion material, the light conversion material receives the first light and converts it into at least a second light exit such that the light exit angle of the light conversion material is greater than 130 degrees, the color temperature is less than 16000, the contrast is greater than 1500:1; the concentration of the light conversion material in the light conversion film is 0.2% to 25%; the light converting material comprises a quantum dot material and/or a fluorescent material.

2. The optical film according to claim 1, wherein the light conversion film comprises a light conversion material layer, and the film thickness of the light conversion material layer is 70 to 135 μm.

3. The optical film according to claim 1, wherein the concentration ratio of the quantum dot material to the fluorescent material is 1:100 to 1:5.

4. A backlight module, comprising:
a light source that emits at least a first light;
the optical film comprises a light converting material that receives the first light and converts it into at least a second light exit such that the light exit angle of the backlight module is matched with a wide viewing angle greater than 120 degrees.

5. The backlight module according to claim 4, wherein the light exit angle of the backlight module is matched with a wide viewing angle greater than 130 degrees, a color temperature less than 16000, and a contrast ratio greater than 1500:1.

6. The backlight module according to claim 4, wherein the optical film comprises a functional layer, and the functional layer is at least one of a diffusion film, a brightness enhancement film, a reflective film, and a prism film.

7. The backlight module according to claim 6, wherein the functional layer comprises at least two of a diffusion film, a brightness enhancement film, a reflective film, and a prism film, the at least two functional layers being bonded by optical bonding, the light conversion material is dispersed in the optical glue.

8. The backlight module according to claim 7, wherein the at least two functional layers completely enclose the optical glue.

9. The backlight module according to claim 4, wherein the concentration of the light converting material in the light conversion film is 0.2% to 25%.

10. The backlight module according to claim 4, wherein the light conversion film comprises a light conversion material layer, and the film thickness of the light conversion material layer is 70 to 135 μm.

11. The backlight module according to claim 4, wherein the light conversion material comprises a quantum dot material and/or a fluorescent material; the particle size of the quantum dot material is 1 to 20 nm; and the concentration ratio of the quantum dot material to the fluorescent material is 1:100 to 1:5.

12. The backlight module according to claim 11, wherein the quantum dot material comprises a blue light quantum dot material, a green light quantum dot material, and a red light quantum dot material, the concentration of the blue light quantum dot material in the quantum dot material is 40% to 65%; the concentration of the green light quantum dot material in the quantum dot material is 15% to 45%, the concentration of the red light quantum dot material in the quantum dot material is 5% to 30%; and the concentration ratio of the green light quantum dot material to the red light quantum dot material is 3:1 to 1.5:1.

13. The backlight module according to claim 4, wherein the optical film comprises a reflective film layer arranged on one side of the light conversion material on the optical path away from the light source, part of the first light passes through the light converting material and is emitted onto the reflective film layer and is partially reflected back to continue to convert the first light into a second light.

14. The backlight module according to claim 4, further comprising:
a first transflective film arranged on the side of the optical path adjacent to the light source on the optical conversion material, passing through the first light and reflecting light outside the first light;
a second transflective film arranged on the side of the optical path away from the light source at least two of the light conversion materials, at least partially reflecting the first light and passing through the light outside the first light.

15. A display device comprising a backlight module, wherein the backlight module comprises a light source that emits at least a first ray of light; the optical film comprises a light converting material that receives the first light and converts it into at least a second light exit such that the light exit angle of the backlight module is matched with a wide viewing angle greater than 120 degrees.

16. The display device according to claim 15, wherein the optical film comprises a functional layer comprising at least two of a diffusion film, a brightness enhancement film, a reflective film, and a prism film, the at least two functional layers being optically bonded, the light converting material being dispersed in the optical glue.

17. The display device according to claim 16, wherein the at least two functional layers completely enclose the optical glue.

18. The display device according to claim 15, wherein the optical film comprises a reflective film layer arranged on one side of the light conversion material on the optical path away from the light source, part of the first light passes through the light converting material and is emitted onto the reflective film layer and is partially reflected back to continue to convert the first light into a second light.

19. The display device according to claim 15, wherein the backlight module further comprises:
A first transflective film arranged on the side of the optical path adjacent to the light source on the optical conversion material, passing through the first light and reflecting light outside the first light;
A second transflective film arranged on the side of the optical path away from the light source at least two of the light conversion materials, at least partially reflecting the first light and passing through the light outside the first light.
